(19) United States
(12) Patent Application Publication
(10) Pub. No.: US 2011/0276415 A1
(43) Pub. Date: Nov. 10, 2011

(54) WINE MARKETING METHOD FOR SPORTING EVENTS

(76) Inventor: Bruce Florine, Chicago, IL (US)

(21) Appl. No.: 12/943,788

(22) Filed: Nov. 10, 2010

Related U.S. Application Data
(60) Provisional application No. 61/259,779, filed on Nov. 10, 2009.

(51) Int. Cl. G06Q 30/00; G06Q 90/00

(52) U.S. Cl. 705/14.73; 705/500

(57) ABSTRACT

What is described is new method of marketing of wine in relation to a sport or a sporting event. What is also described is a new method of integrating and selling wine at the sporting event or in association with a sport. The methods including the creation of a wine club for selecting and licensing of brands to be associated with selected high quality wines each brand linked with a famous player. Further, the wine club will brand the sport association in association with the wine club and the branded wines. The method also include the use of a wide range of marketing outlets to help promote the wine including the construction of temporary structures to be placed at selected sports events and tournaments, direct sales, sales to corporate programs, offering of travel services, concession stands, or existing clubhouses.

### FIELD OF THE DISCLOSURE

The present disclosure relates generally to an improvement to marketing methods, and more particularly, to a personalized method of marketing athlete branded wines in association with an association brand or a sport association brand to increase sales of wine of the Wine Club at a sporting event, online, or at other outlets.

### BACKGROUND

Improved methods of advertisement, used by the marketplace are desirable in a market-based economy. Advertisers benefit from targeted or personalized mediums of communications that reach specific segments of the population. Since the needs and consuming habits of specific segments of the population are easier to ascertain and target, methods of advertisements, used in tandem with apparatus for advertising to a specific segment are more likely to increase the efficiency of the marketing and lead to enhanced sales.

Advertising in the modern world has reached a plateau where customers are often blaze by passive advertisements. Once saturation occurs, the placement of ads before a customer often has the opposite effect. A negative experience is projected to potential customers instead of a suggestive reinforcement. High-end segments are more prone to saturation. In addition, this very difficult segment of the population shies away from advertisement and seeks activities away from the media, protected from the advertising. Golfers are the apotheosis of this situation, but the same can also be said of any market segment to some extent.

Golf events are organized at different venues, but the most famous players are members of the Professional Golf Association (PGA). Some key players are well known, they have a loyal fan base, and their fans are often vulnerable to marketing associated with the player's identity.

While a handful of the most famous golfers associate their image with large international brands, other less famous golfers are left to find smaller and less lucrative sponsoring deals of goods that can often dilute the image of the famous golfer. Often, these golfers have to make a decision between revenues and association with a lesser brand or protecting their image.

Over the years, some golfers have associated themselves with wine. The image of the golfer is branded on a bottle in an effort to promote the sale of wines that often are not very successful without the branding. As a result, the golfer's image and reputation can be tarnished when the branding is made. One of the objectives of this invention is to offer famous golfers with a branding opportunity in the wine industry while maintaining a high level of quality of the wine itself.

U.S. wine consumption is in a steady multi-year ascent for over fourteen years. Today, the golfer and wine drinker index score is high, making the golf and wine combination a growing and emerging opportunity. Wine accounts for about 30% of all alcohol consumed in the United States. There are thousands of wines on the market, with the largest wine company owning only as little of 9% of the segment.

Unlike in the beer and spirit industry where the players are larger and are in an oligopoly, the wine producers are faced with competitors using scrappy packaging, promotions, and retail placement tactics that are often an obstacle to golfers who want to enter this market and are fearful of being victims of this type of behavior. The current invention offers a system and method for ensuring a minimum of branding and quality with wines.

Today there are thousands of private, semi-private and resort golf courses in the United States serving wine at their clubs. There is no centrally-organized national effort or structure designed to influence and control the distribution and selection of wine directed to golf clubs and golf related events. Today, the PGA Tour associates this brand with one or two types of alcoholic beverages to a very limited extent. The PGA Tour also would benefit from licensing its brand if it could be assured of a minimum level of quality in the product it licenses, such as wines.

Further, some golf tournaments do have official sponsored wines as driven by some local distributors, but in these situations, the organizers of the tournaments are often required to order a fixed quantity of the wine and must then sell the wine. What is needed is a method of marketing wines that allows tournament directors to associate themselves with selected wines without the hassles of having to manage sales, distribution, storage, etc.

Today some golfers have private labels such as Greg Norman, Luke Donald, Ernie Els, Gary Player, and Nick Faldo. While the Greg Norman wines are successful at retail because of the quality of the wine, the others struggle to acquire status and traction in the marketplace. For example, the publication Golf Digest has little or no wine advertisement, as advertisements for any single brand is often cost prohibitive. One of the advantages of this invention is to overcome these problems and allow for many private labels to gain importance in the marketplace to the benefit of the golfer, the private label, the wine producer, and any other third party involved in this transaction.

One of the purposes of this method is to increase the share of wine consumed by golf enthusiasts that are branded to golfers or a golf trade association. Another purpose of this method is to increase direct and indirect sales and promote a level of confidence in golfer traded wines in the marketplace. What is desired is new method of advertising and market penetration for the promotion and sale of wine branded to a sport athlete or a sporting event in which the sport athlete can operate.

### SUMMARY

What is described is new method of marketing of wine in relation to a sport or a sporting event. What is also described is a new method of integrating and selling wine at the sporting event or in association with a sport. The methods including the creation of a wine club for selecting and licensing of brands to be associated with selected high quality wines each brand linked with a famous player. Further, the wine club will brand the sport association in association with the wine club and the branded wines. The method also includes the use of a wide range of marketing outlets to help promote the wine including the construction of temporary structures to be placed at selected sports events and tournaments, direct sales, sales to corporate programs, offering of travel services, concession stands, or existing clubhouses.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 is a schematic illustration of the different steps of the method of marketing of wine for a sporting association in accordance with an embodiment of the present disclosure.

FIG. 2 is a schematic illustration of the different steps of the method of integrating and selling wine at a sporting event according to an embodiment of the present disclosure.

FIG. 3 a sample illustration of the grounds at a sporting event where the different structures are positioned according to an embodiment of the present disclosure.

### DETAILED DESCRIPTION

For the purposes of promoting and understanding the invention and principles disclosed herein, reference is now made to the preferred embodiments illustrated in the drawings, and specific language is used to describe the same. It is nevertheless understood that no limitation of the scope of the invention is thereby intended. Such alterations and further modifications in the illustrated devices and such further applications of the principles disclosed as illustrated herein are contemplated as would normally occur to one skilled in the art to which this disclosure relates.

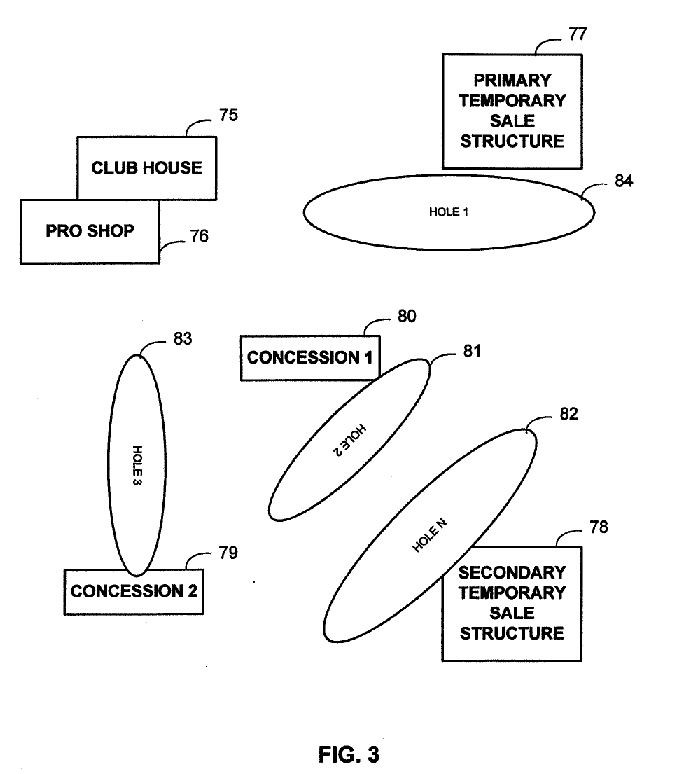

FIG. 3 shows a sample illustration of the grounds at a sporting event where the different structures 75 to 79 are positioned according to an embodiment of the present disclosure. While golf courses are designed differently based on a multitude of reasons, all these courses have a club house 75 where players go to register, collect or store their bags and rent a cart for moving around a series of holes 81 to 84 placed across a surface of land. In normal golf environments, the owners of the golf course try to preserve the environment and thus limit the number of manmade structures across the ground. When organizers organize tournaments or other types of events, in addition to the club house 75 or any associated pro shop 76 where golf equipment are sold, it may be possible to set up concessions 79, 80 at different locations across the course.

These concessions 79, 80 can also be located next to the club house, in the parking or any other location to reach patrons that may not have full access to the club house. In one embodiment of the methods, the use of primary and secondary temporary sale structures 77, 78 are contemplated. For example, a foldable structure with a 30 feet by 40 feet raised and carpeted platform with cover tent al fresco is contemplated. These structures 77, 78 can be located between the tee and the green with a capacity of 80 in one preferred embodiment. As part of the design of these structures, the interior may be made to look “sophisticated” with a high-top communal table, bouquets on the tables, and modular elements to fill in the space next to a wine bar built in the interior of the structure.

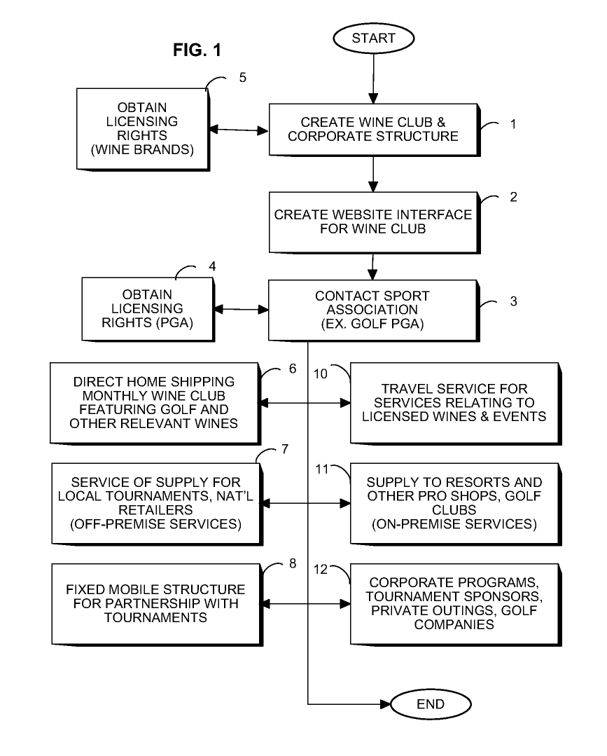

FIG. 1 shows a method of marketing of wine for a sporting association, for example a golf association. The method as contemplated in one embodiment, comprises the steps of creating a corporate structure for forming a wine club with a plurality of members 1. The corporate structure can be a for profit corporation, a non for profit corporation, a partnership, a limited liability corporation or even a privately held corporation. A wine club is then created, the wine club is designed to have a plurality of activities including a regular publication to members with advertisement and featured wines, a database of wines that are featured or vetted by the wine club, a list of members, and ultimately even a brick and mortar structure for sale of wines featured in the wine club.

Many wine clubs offer selections of wines to their members each month and shipment to these members using mail. Wine club managers will research wines to be featured and sold by the wine club to its members. Wine clubs can offer manufacturers an outlet for distribution and advertisement of any featured wine to members. The Wine club can also serve as intermediary or even manager of the interest of a professional player such as a golfer. The Wine club manager will offer to a wine producer to enter into a branding contract with a known golfer for a fixed cost or a variable cost. The producer of the wine may be assured that the wine thus branded will be featured and promoted directly to the Wine Club members for the sale of a certain volume of wine, and then for sale at different locations around the country.

The Wine Club serves as both the gatekeeper of the selection and thus quality of the wine it selects to be branded and the emissary to contact players to offer them the sponsorship deal in association with a good wine of a fixed and rated quality. The Wine Club can negotiate, broker, obtain, secure, or own licensing rights 5 to different brands of wine and in turn each of these brands can be associated with an athlete or golfer famous in the sport at which the method of marketing is directed.

While the current disclosure describes the current best mode as a method to be used in conjunction with the sport of golf, any other activity is contemplated. For example, regional chess competitions, annual triathlon championships, marathons, even local charity races can be associated with this method. For example, at each Thanksgiving a number of “Turkey Trots” foot races are organized around the country. Some of the runners are famous and well liked by the running community. The sports association can by the U.S.A. Track and Field who can give a license in conjunction with licenses obtained from different Olympic class runners to help sell branded wines. A tent or other temporary structure can be used with chairs and even massage experts to help create a sophisticated experience for runners and their fans.

Next, the method contemplates the step of creating a website 2 on a computer interface such as any known computer or server for creating an interface over the internet for marketing both the Wine Club and the different brands of wine associated with the sport. The advantages of websites interfaces for social groups and clubs is well known, they include the capacity to send daily or weekly email reminders at low cost, to create discussion groups to help rate and grade wines, and also to include marketing materials from different golf events and sport promoters and tournament directors.

The method then requires the use in some embodiments, of a sports association 3 related to the sporting event and obtaining licensing rights 4 to a brand such as the sports association for marketing of the association brand alongside the brands of wine that have also been licensed 5. In one embodiment, the sport association is the PGA and the sporting event is a golf tournament part of the PGA.

Finally, FIG. 1 provides for six different other types of marketing elements 6, 7, 8, 10, 11, and 12 where each provides additional marketing outlets for the method as described above. For example, what is also contemplated is the offering to members of the wine club monthly featured wines and directly shipping 6 the wines to their residences using conventional shipping methods. While the distribution of monthly wines by wine clubs is known, what is not known is the use of this technique in conjunction with the branding of individual known sports athletes in conjunction with the sports association branding. For example, as a member of the PGA® or LPGA® Wine Club who wants to attend the Shell Houston Open tournament, the advertisement of a new 2013 Nick Faldo Sauvignon endorsed by the Wine Club creates a completely different commercial impression and marketing experience than simply an ordinary wine club who advertises the 2013 Nick Faldo Sauvignon.

In an different possible advantage of this marketing system is the offer to Wine Club members of travel services 10 to wineries associated with the different brands of wine licensed for wine tasking and other wine related events. Once again, it is one thing for a wine club to organize a tour of famous Bordeaux in France, but it is quite another to advertise “The PGA® Wine Club invites you along with Nick Faldo to discover his new 2013 Sauvignon at the winery.”

Other marketing outlets include marketing to local tournament organizers or national retailers 7 using either the internet, or marketing brochures to supply branded wines with both the brand of the sports association and the brand of the different wines associated with the famous players. As explained in the above examples, once again the novelty and the marketing leverage created by the branding and method of marketing is unique and relevant. Local tournament organizers in a small municipality will definitely improve their playing enjoyment by advertising: “East Angus Golf Club Annual Tournament, featuring wines by 10 of the top golf players from the PGA® Wine Club itself.”

Finally, what is also described is the creation of a mobile structure 8 to be moved from one sporting event to the next where the mobile structure is branded with both the brand of the sports association and the brand of the different wines associated with the famous players and the mobile structure is a sales point for the marketing and sale of the different branded wines at the sporting event. Finally, what is also contemplated is the step of marketing and supplying the different branded wines to corporate programs 12, tournament sponsors, private outings, and golf supply corporations, or any other sport related outlet where wines may be sold.

In the case the method is applied to, for example a running event such as the Chicago Marathon, and the brand of the Chicago Marathon is obtained alongside the name of the Olympic runner Hall on a branded wine, a small sample bottle could be placed in the bag given to runners before a race alongside. The impact of a branded wine to Hall in this context of the Chicago Marathon in association with the Wine Club structure is a novel and non obvious concept.

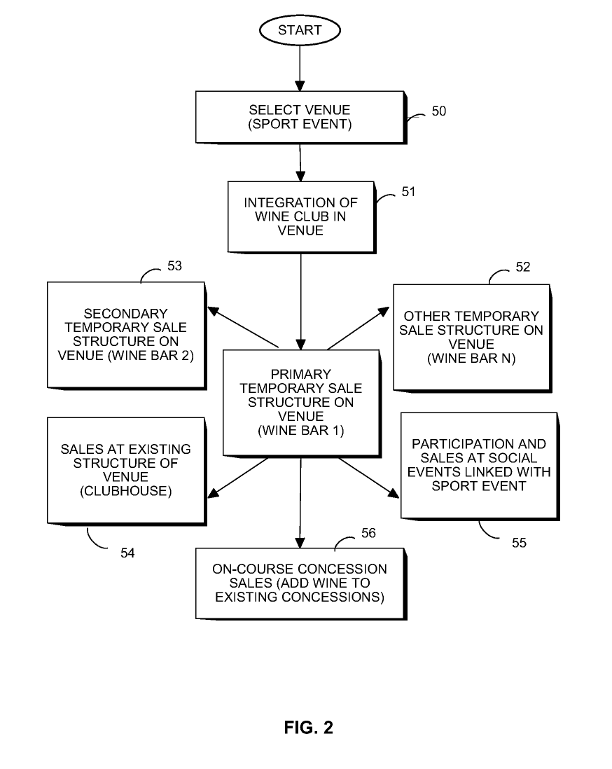

At FIG. 2, what is shown is a method of integrating 51 and selling wine at a sport event 50 such as a PGA golf tournament. In a first step creating a primary temporary structure 1 at a first location as shown as 77 on FIG. 3 for the sale of a plurality of different branded wines, each brand being associated and branded based on a famous athlete in a sport related to the sport event and the temporary structure branded with the licensed brand of a sports association related to the sporting event. Then what is created 53 is a secondary temporary structure 78 for the sale of the plurality of different branded wines located at a second location also shown at FIG. 3 at the sporting event.

What is contemplated is the placement of at least one of the plurality of different branded wines at the existing structure 54 such as the club house 75 where the sport event is held, and placing 56 at least one of the plurality of different branded wines at least one concession 79, 80 as shown at FIG. 3 at the sport event and placing at least one of the plurality of different branded wines at a social event linked with the sport event.

Persons of ordinary skill in the art appreciate that although the teachings of the disclosure have been illustrated in connection with certain embodiments, there is no intent to limit the invention to such embodiments. On the contrary, the intention of this disclosure is to cover all modifications and embodiments failing fairly within the scope of the teachings of the disclosure.

What is claimed is:

1. A method of marketing of wine for a sporting event, the method comprising the steps of:
creating a corporate structure for forming a wine club with a plurality of members, wherein the wine club has licensing or purchase rights to different brands of wine, each brand being associated with an athlete famous in the sport at which the method of marketing is directed,
creating a website on a computer interface over the internet for marketing both the wine club and the different brands of wine associated with the sport;
contacting a sports association related to the sporting event and obtaining licensing rights to a brand of the sports association for marketing of the association brand alongside the brands of wine.

2. The method of claim 1, wherein the sport event is golf, and the athletes are golfers.

3. The method of claim 2, further comprising the step of offering to members of the wine club monthly featured wines and directly shipping the wines to their residences using conventional shipping methods.

4. The method of claim 3, further comprising the step of offering to members travel services to wineries associated with the different brands of wine licensed for wine tasking and other wine related events.

5. The method of claim 4, further comprising the step of marketing to local tournament organizers or national retailers using either the internet, or marketing brochures to supply branded wines with both the brand of the sports association and the brand of the different wines associated with the famous players.

6. The method of claim 5, further comprising the step of creating a mobile structure to be moved from one sporting event to the next where the mobile structure is branded with both the brand of the sports association and the brand of the different wines associated with the famous players and the mobile structure is a sales point for the marketing and sale of the different branded wines at the sporting event.

7. The method of claim 5, further comprising the step of marketing and supplying to golf resorts and other pro shops and golf clubs the different branded wines.

8. The method of claim 5, further comprising the step of marketing and supplying the different branded wines to corporate programs, tournament sponsors, private outings, and golf supply corporations.

9. A method of integrating and selling wine at a sporting event, the method comprises the steps of:
creating a primary temporary structure at a first location for the sale of a plurality of different branded wines, each brand being associated and branded based on a famous athlete in a sport related to the sport event and the temporary structure branded with the licensed brand of a sports association related to the sporting event,
creating a secondary temporary structure for the sale of the plurality of different branded wines located at a second location at the sporting event,
placing at least one of the plurality of different branded wines at the existing structure where the sport event is held,
placing at least one of the plurality of different branded wines at least one concession at the sport event, and
placing at least one of the plurality of different branded wines at a social event linked with the sport event.

10. The method of claim 9, wherein the sport event is a golf tournament, the athletes are golfers, and the sport association is the Professional Golf Association (PGA).
